(19) United States
(12) Patent Application Publication
(10) Pub. No.: US 2015/0045710 A1
(43) Pub. Date: Feb. 12, 2015

(54) Breathable Veterinary Bandage and Method

(71) Applicant: Guardian Equine Products LLC, Loxahatchee, FL (US)

(72) Inventor: Robert Marti Pastor, Loxahatchee, FL (US)

(73) Assignee: Guardian Equine Products LLC, Loxahatchee, FL (US)

(21) Appl. No.: 13/963,028

(22) Filed: Aug. 9, 2013

(51) Int. Cl. A61D 9/00

(52) U.S. Cl. CPC A61D 9/00
USPC 602/43

(57) ABSTRACT

A breathable bandage is provided for covering a portion of an animal without contacting a wound. The animal may be an equine. The bandage may include a wrapping, window, spacer, and breathable material. The wrapping may at least partially contact a body surface of the animal and may be stretchable and/or cloth. The spacer may be located between the wrapping and the body surface substantially about the window to elevate window above the body surface. The breathable material may be attached to the wrapping that covers the window to promote air flow and restrict passage of objects. A method is provided for applying a breathable bandage.

### FIELD OF THE INVENTION

The invention relates to a veterinary bandage. More specifically, the invention relates to a breathable bandage to dress a wound on an equine or other animal.

### BACKGROUND

People have been domesticating and working with equines since early humanity. Horses and other equine animals have provided labor, sport, and recreation to people for countless years. In return, people care for their equines by keeping them fed, sheltered, and healthy.

Unfortunately, equines sometimes become subject to injuries and infections, for example, lacerations, saddle sores, scrapes, abrasions, punctures, cutaneous habronemiasis, and other wounds. Summer sores, the common name of cutaneous habronemiasis, involve an inflammation and lesion caused by interacting with the larvae of a stomach parasite. Typically, the inflammation is cause by the parasites Habronema muscae, Habronema microstoma, and Draschia megastoma. Eggs of these parasites are passed in the dung of the equine. The parasite eggs then hatch into nematode larvae to be consumed by larvae of flies, in which the parasite will continue to develop. The adult flies then contact a mucous membrane or open wound on the equine, transporting the parasite larvae onto the exposed tissue of the equine. The parasite larvae cause reaction with the mucous tissue of the equine, resulting in inflammation and lesions.

To treat these wounds, caretakers of an equine apply bandages to the lesions. However, traditional bandages make contact with the wound, causing discomfort to the animal. Alternatively, caretakers will clean the lesions caused by the parasite and leave the sores exposed to air to expedite healing. However, exposed sores are typically contacted by additional flies that deposit additional parasites and perpetuate the inflammation.

What is needed is a breathable bandage to cover a wound on an equine. What is also needed is a bandage that may cover a wound without making contact. What is needed is a bandage to minimize contact of objects, including insects, which perpetuate the inflammation. What is needed is a method for dressing a wound using a breathable bandage.

### SUMMARY

The present invention provides a breathable bandage to cover a wound on a horse or other animal. The present invention also provides a bandage that to cover a wound without making contact. Additionally, the present invention provides a bandage that may minimize contact of objects, including insects, which perpetuate the inflammation. Furthermore, the present invention provides a method for dressing a wound using a breathable bandage. For purposes of providing an example only and without limiting the structure, function, purposes and use of the invention, the animal on which the bandages and methods of this invention may be used is often referred to as an equine and/or horse and the bandage may be referred to as an equine bandage herein. Throughout this disclosure, the term equine is used in accordance with its ordinary meaning as a noun to describe an animal member of the family Equidae and as an adjective to describe objects of, relating to, or resembling a horse, mule, donkey, or other member of the Equidae family.

The present invention provides a breathable bandage that may cover a portion of an equine or other animal without contacting a wound. Examples of wounds coverable by the bandage of the present invention include, but should not be limited to injuries, infections, lacerations, saddle sores, scrapes, abrasions, punctures, cutaneous habronemiasis, and other wounds that would be apparent to a person of skill in the art. The bandage may include a wrapping, window, spacer, and breathable material. The wrapping may at least partially contact a body surface of the equine and may be stretchable and/or cloth. The wrapping may include an adhesive on its bottom surface. The window may be included by the wrapping. The spacer may be located between the wrapping and the body surface of the equine substantially about the window to advantageously elevate the window above the body surface. The breathable material may be attached to the wrapping over the window to promote air flow and restrict passage of objects, such as insects. A method is also provided for applying a breathable bandage.

The breathable bandage may advantageously protect a wound on an equine, such as wounds caused by summer sores. The breathable material covering the elevated window may minimize or eliminate contact from flies carrying the parasite that cause the characteristic inflammation of summer sores. By denying the parasite infected flies contact to open wounds on the equine, the breathable bandage advantageously breaks the cycle of infection and facilitates healing of the sores.

According to an embodiment of the present invention, a bandage is provided for covering a portion of an animal including a wrapping, a window, a spacer, and a breathable material. The wrapping may at least partially contact a body surface of the animal. The window may be located in the wrapping to expose the portion of the body surface. The spacer may be located between the wrapping and the body surface substantially about the window. The spacer may elevate a top of the window above the body surface. The breathable material may be attached to the wrapping to cover the window. The breathable material may promote air flow and restrict passage of objects. The window covered by the breathable material may be configured to substantially cover a wound on the animal.

In another aspect, the wrapping may include a stretchable material.

In another aspect, the stretchable material may include cloth.

In another aspect, the bandage may further include an adhesive applied to at least part of a bottom surface of the wrapping.

In another aspect, the bandage may include a first side and a second side. The bandage may be configured to wrap around the portion of the animal such that the first side is securable to the second side.

In another aspect, the spacer may elevate the window above the wound.

In another aspect, the breathable material may include a screen.

In another aspect, the objects may include insects. The screen may include a mesh with sufficiently small openings to minimize passage the insects.

According to an embodiment of the present invention, a bandage may be provided for an animal including a wrapping with a first side and second side being securable to the first side, a window, a spacer, and a breathable material. The wrapping may at least partially contact a body surface of the animal. The window in the wrapping may expose a portion of the body surface. The spacer may be located between the wrapping and the body surface. The spacer may elevate a top of the window above the body surface. The breathable material may include a screen attached to the wrapping and cover the window to promote air flow and restrict passage of objects. The bandage may be configured to wrap around the portion of the animal.

In another aspect, the wrapping may include a stretchable material.

In another aspect, the stretchable material may include cloth.

In another aspect, the window may be configured to substantially cover a wound on the animal.

In another aspect, the spacer may elevate the window above the wound.

In another aspect, the spacer may be located substantially about the window.

In another embodiment, the bandage may further include an adhesive applied to at least part of a bottom surface of the wrapping.

In another aspect, the breathable material may include a screen.

In another aspect, the objects may include insects. The screen may include a mesh with sufficiently small openings to minimize passage the insects.

A method aspect is provided for protecting a wound on an animal using a bandage with a wrapping, a spacer and a window. The method includes locating the window over a portion of the animal with the wound, wherein the window is located in the wrapping. The method also includes positioning the spacer around the wound to elevate a top of the window over the wound, wherein the spacer is attached to the wrapping adjacent to the window, and wherein the spacer is locatable between the wrapping and a body surface of the animal. Additionally, the method includes at least partially contacting the body surface of the animal with the wrapping. Furthermore, the method includes securing the bandage using the wrapping. A breathable material may be attached to the wrapping and covers the window is configured to substantially cover the wound on the animal, promote air flow, and restrict passage of objects.

In another aspect of the method, the bandage may include a first side and a second side, wherein the bandage is configured to wrap around the portion of the animal such that the first side is securable to the second side.

In another aspect of the method, the wrapping may include a stretchable cloth, and wherein the spacer may be located substantially about the window to elevate the window above the wound.

In another aspect of the method, the breathable material may include a screen, wherein the objects may include insects, wherein the screen may include a mesh with sufficiently small openings to minimize passage the insects.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a top plan view of a bandage, according to an embodiment of the present invention.

FIG. 2 is a top plan view of a bandage, according to an embodiment of the present invention.

FIG. 3 is a bottom plan view of the bandage of FIG. 1.

FIG. 4 is a top plan view of the bandage of FIG. 2.

FIG. 5 is a side elevation view of the bandage of FIG. 1.

FIG. 6 is a side elevation view of the bandage of FIG. 2.

FIG. 7 is a perspective view of the bandage of FIG. 1 worn by an equine.

FIG. 8 is a perspective view of the bandage of FIG. 2 worn by an equine.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a breathable bandage to dress a portion of an animal. Generally, in the interest of clearly describing the invention, this disclosure will be discussed in the context of a bandage for covering a portion of an equine having a wound. However, those of skill in the art will appreciate additional applications of the bandage after having the benefit of this disclosure. Skilled artisans will additionally appreciate that the bandage may be applied to virtually any animal, and is not intended to be limited for use only with equines. The following description, given in the context of an equine bandage, is not intended to limit the present invention in any way.

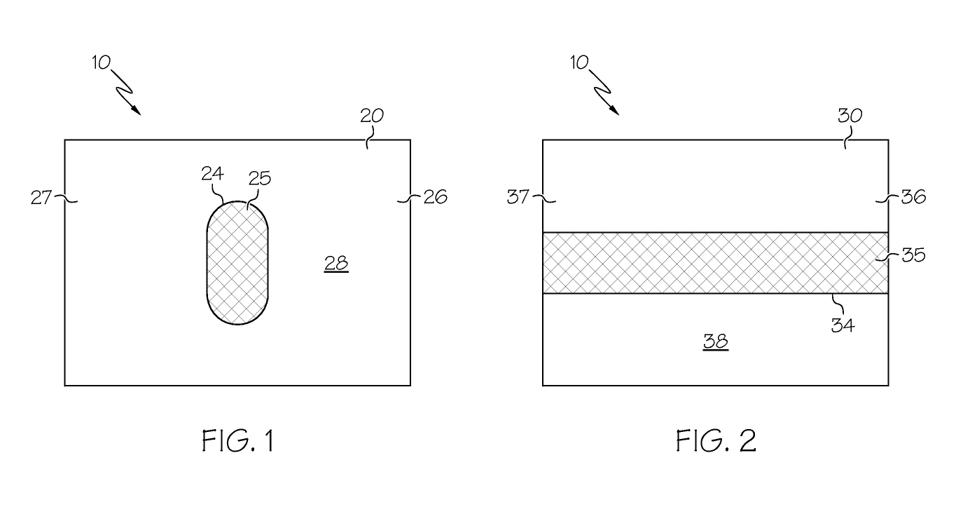

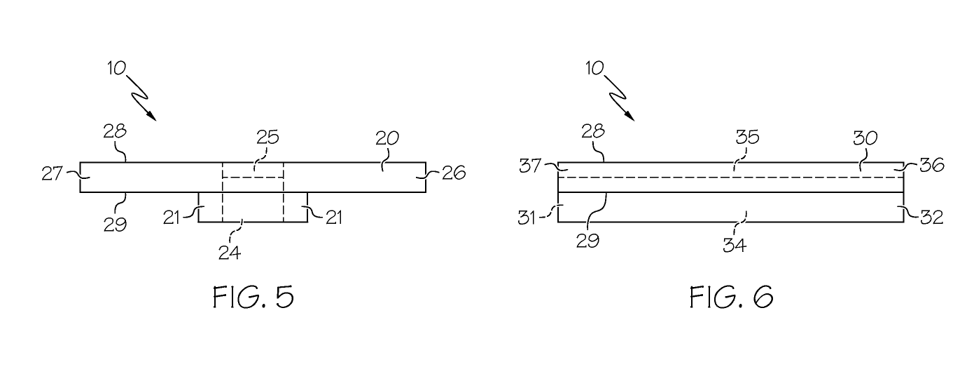

Referring now to FIGS. 1-6, the bandage may include a wrapping, window, spacer, and breathable material. The wrapping may be cloth and include the window. A spacer may be located between the wrapping and a body surface of the equine. A breathable material may be located over the window to promote air flow and restrict passage of objects, such as insects and other carriers of infection.

In an embodiment of the present invention illustrated by FIGS. 1, 3, and 5, the wrapping 20 may include an elongated length of material extending from a top portion to a bottom portion and bordered by a first side 26 and a second side 27. The wrapping 20 may include a top surface 28 to face outwardly from an equine dressed by the bandage 10. The wrapping 20 may also include a bottom surface 29 to face inwardly to a body surface of the equine dressed by the bandage 10. A window 24 may be located in the wrapping 20, which may be an area of removed material to allow a wound covered by the bandage 10 to breathe. The window 24 may be covered by a breathable material 25, which may be attached to the wrapping 20 on either its top surface 28, the bottom surface 29, or in the interior of the window 24.

A spacer 21 may be included on the bottom of the wrapping 20. In examples where the breathable material 25 is attached to the wrapping 20 on its top surface 28 or included in the interior of the window 24, the spacer 21 may be attached to the wrapping 20 on the bottom surface 29. In examples where the breathable material 25 is attached to the wrapping 20 on its bottom surface 28, the spacer 21 may be attached to the wrapping 20 on the bottom surface 29 with the breathable material 25 attached between the spacer 21 and the wrapping 20. The window 24 may extend through the area enclosed by the spacer 21.

The bandage may be configured in virtually any shape or size. The bandage may be tailored relative to the type of wound to be covered by the bandage and/or the type of animal to which the bandage may be applied. The elements of the bandage may also vary in size across different configurations of the bandage. For example, one configuration of the bandage may include a large wrapping portion and a small window portion, which may be provided to cover a small wound but have a large surface area for attachment to the animal. In another configuration, the bandage may include a large window portion and a narrow elongated wrapping, which may be provided to wrap around a portion of an animal, such as a knee. Those of skill in the art will appreciate a plethora of additional configurations of sizes and shapes by which the bandage may be configured consistent with the scope and spirit of this disclosure.

In an embodiment of the present invention illustrated by FIGS. 2, 4, and 6, the wrapping 30 may include an elongated length of material extending from a top portion to a bottom portion and bordered by a first side 36 and a second side 37. The wrapping 30 may include a top surface 38 facing outwardly from an equine to be dressed by the bandage 10. The wrapping 30 may also include a bottom surface 39 facing inwardly to a body surface of the equine to be dressed by the bandage 10.

A window 34 may be located in the wrapping 30, which may be an area of removed material to allow a wound covered by the bandage 10 to breathe. The window 34 may run within the wrapping 30 longitudinally from the first end 36 to the second end 37, extending the entire length of the wrapping 30. The border between the wrapping 30 and the window 34 may be approximately parallel at the top and bottom edges of the window 34. The window 34 may be covered by a breathable material 35, which may be attached to the wrapping 30 on either its top surface 38, the bottom surface 39, or in the interior of the window 34.

Spacers may be included on the bottom of the wrapping 30. The spacers may collectively include a top spacer 31 located at the top of the window 34 and a bottom spacer 32 at the bottom of the window 34. Where the breathable material 35 is attached to the wrapping 30 on its top surface 38 or included in the interior of the window 34, the top and bottom spacers 31, 32 may be attached to the wrapping 30 on the bottom surface 39. Where the breathable material 35 is attached to the wrapping 30 on its bottom surface 39, the top and bottom spacers 31, 32 may be attached to the wrapping 30 on the bottom surface 39 with the breathable material 35 attached between the top and bottom spacers 31, 32 and the wrapping 30, respectively. The window 34 may extend through the area enclosed by the top and bottom spacers 31, 32.

The wrapping will now be discussed in greater detail. The wrapping may be constructed using a material capable of being affixed to, encircling, or otherwise surrounding a portion of an equine. The wrapping may be constructed using virtually any material capable of covering a portion of the animal. The material may include cloth. The wrapping may also be stretchable and/or may include elastic. By being stretchable, the bandage may provide compression to a portion of the body on which the bandage is applied. Additionally, by constructing the bandage with a stretchable material, the bandage may be securable to the equine more easily.

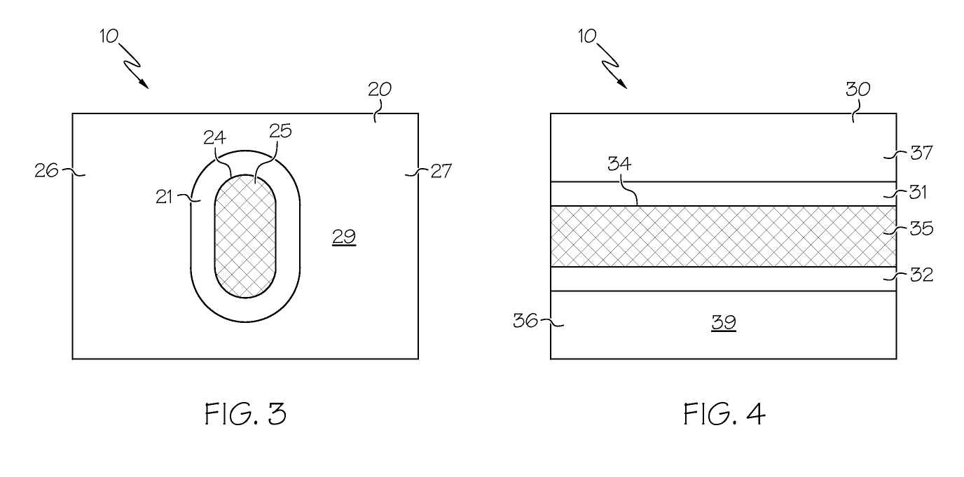

The window will now be discussed in greater detail. The window 24 may include an area removed from the wrapping 20, for example, as shown in FIGS. 1 and 3. Alternatively, the window 34 may include an area located between two pieces of the wrapping 30, for example, as shown in FIGS. 2 and 4. Material from the wrapping may be removed at the window to provide an area of the bandage that does not directly contact a wound. The window may be covered with a breathable material, for example, over a top of the window, which may facilitate air flow through the window.

The breathable material will now be discussed in greater detail. The breathable material may be virtually any material through which air may pass. Additionally, the breathable material may restrict the passage of objects, including flies and other parasite carrying insects. Skilled artisans will appreciate objects to broadly include any material or organism that may undesirably contact a wound. Objects may include, without limitation, stones, sticks, insects, nematodes, plant material, animal waste, or other undesirable material that would be apparent to a person of skill in the art. Optimally, the breathable material will allow air to pass with maximum air flow characteristics while minimizing contact from insects that may inflame and/or infect the covered wound. Examples of the breathable material may include a screen, loosely knit cloth, microfiber, mesh, and/or other breathable materials that would be apparent to a person of skill in the art.

The breathable material may be located about and substantially cover the window. The breathable material may be attached to the wrapping on the top or bottom surface of the wrapping via adhesive, stitching, welding, or another form of attachment that would be apparent to a skilled artisan. Alternatively, the breathable material may be included within the interior of the wrapping using one or more of the above mentioned form of attachment.

The breathable material may advantageously cover a wound on an equine, such as a summer sore inflammation caused by a fly carried parasite, breaking the cycle of treatment and subsequent reinfection. The breathable material also beneficially minimizes restriction of air flow to the wound, expediting the healing process. Also, since the breathable material is elevated over the wound by the spacer, which will be discussed below more detail, irritation of the wound is minimized for the equine.

The spacer will now be discussed in greater detail. The spacer may be a piece of material to raise the level of at least a top of the window above the body surface of the equine being covered. The spacer may be constructed using a variety of materials, such as, without limitation, nylon, cloth, foam, or another material that would be apparent to a person of skill in the art. The spacer may be attached to the wrapping via stitching, adhering, welding, and/or another form of attachment that would be apparent to a person of skill in the art. In one embodiment, the spacer may raise the breathable material covering the window to an elevation above the body surface of the equine as not to contact a wound on the body surface below.

In an embodiment of the present invention, the bandage may be configured to wrap around and/or encircle a portion of the equine. The first end of the wrapping may be securable to the second end of the wrapping to substantially hold the bandage in place. The first and second ends of the wrapping may be securable via adhesive, hook and loop, stitching, or another form of attachment that would be apparent to a person of skill in the art.

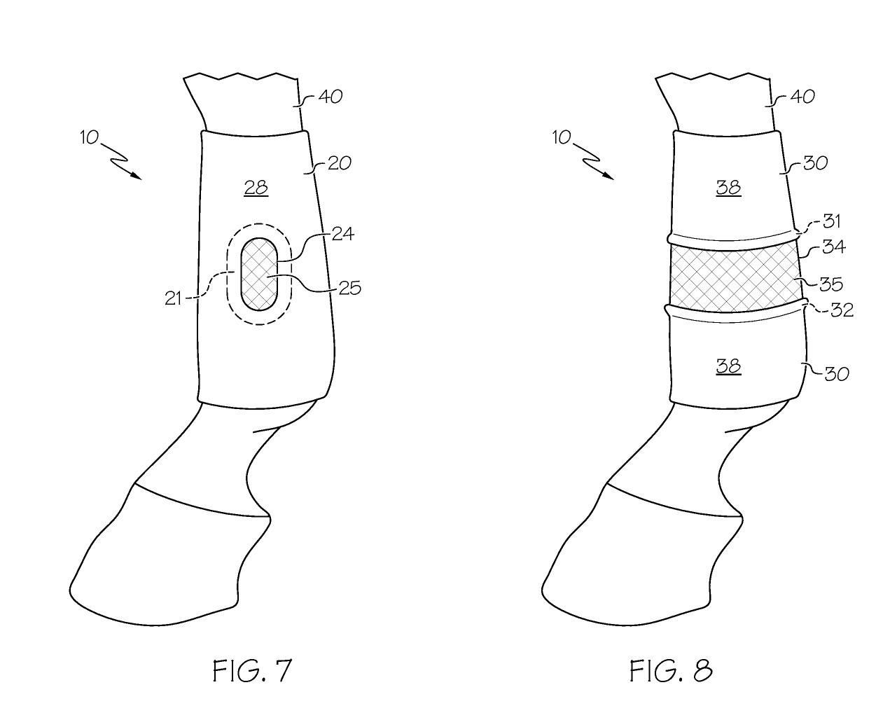

Application of the bandage 10 in the embodiment illustrated by FIGS. 1, 3, and 5 on the limb 40 of an equine is illustrated in FIG. 7. Here, the bandage is applied to the leg 40 of the equine such that the first end 26 and the second end 27 of the bandage 10 are removably attached and the window 24 is located above the wound. Similarly, application of the bandage 10 in the embodiment illustrated by FIGS. 2, 4, and 6 on the limb 40 of an equine is illustrated in FIG. 8. Here, the bandage 10 is applied to the leg 40 of the equine such that the first end 36 and the second end 37 of the bandage 10 are removably attached and the window 34 is located above the wound. Skilled artisans will appreciate that the above discussed examples are provided for illustrative purposes only and are not intended to limit the possible embodiments of the invention in any way. Those of skill in the art will additionally appreciate numerous embodiments of the bandage and applications of the same, which may include being adhered to a surface of the animal, wrapped about the animal at a place other than a leg, or otherwise placed on an animal in a way consistent with this disclosure.

In one illustrative embodiment, provided here as an example and not to be viewed as limiting in any way, the bandage may be applied to a limb of the equine. In this example, the bandage may be wrapped around the portion of the limb with the wound, locating the window over wound. The first end of the wrapping may be securable to the second end of the wrapping, holding the bandage over the limb.

In an embodiment of the present invention, an adhesive may be included on the wrapping to assist in holding the bandage in place on the equine. More specifically, the adhesive may be included on at least a portion of the bottom surface of the wrapping. The adhesive may secure the bandage to the body surface of the equine. In another embodiment, the adhesive may also be applied to a bottom surface of the spacer that may contact the body surface of the equine. The adhesive may be a bandage grade adhesive.

In operation, the bandage may be applied to a portion of the equine to protect a wound. The method may include locating the window of the bandage over a portion of the equine having the wound. The window may be located in the wrapping. The method may also include positioning the spacer around the wound to elevate the window over the wound. The bandage may include a breathable material applied to the window at the elevated position to minimize contact of the bandage with the wound. The breathable material may advantageously cover the wound, promote air flow, and restrict passage of objects, such as insects.

The method may also include at least partially contacting the body surface of the equine with the wrapping of the bandage. The bandage may then be secured to the equine by using the wrapping. The bandage may be configured to wrap around a portion of the equine such that the first side of the wrapping is securable to the second side of the wrapping. Alternatively, the bandage may include an adhesive on at least part of the bottom surface of the wrapping, allowing the bandage to be adhered to a body surface of the equine.

In this method, the wrapping may include a stretchable cloth. The spacer may be located substantially about the window to elevate the window above the wound. Additionally, the breathable material may include a screen, which may have a mesh with sufficiently small openings to minimize passage of insects.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A bandage for covering a portion of an animal comprising:
a wrapping to at least partially contact a body surface of the animal;
a window in the wrapping to expose the portion of the body surface;
a spacer located between the wrapping and the body surface substantially about the window, wherein the spacer elevates a top of the window above the body surface; and
a breathable material attached to the wrapping that covers the window to promote air flow and restrict passage of objects;
wherein the window covered by the breathable material is configured to substantially cover a wound on the animal.

2. The bandage of claim 1, wherein the wrapping comprises a stretchable material.

3. The bandage of claim 1, wherein the wrapping comprises cloth.

4. The bandage of claim 1, further comprising an adhesive applied to at least part of a bottom surface of the wrapping.

5. The bandage of claim 4, wherein the bandage further comprises a first side and a second side, wherein the bandage is configured to wrap around the portion of the animal such that the first side is securable to the second side.

6. The bandage of claim 1, wherein the spacer elevates the window above the wound.

7. The bandage of claim 1, wherein the breathable material comprises a screen.

8. The bandage of claim 7, wherein the objects comprise insects, wherein the screen comprises a mesh with sufficiently small openings to minimize passage the insects.

9. A bandage for an animal comprising:
a wrapping of stretchable material to at least partially contact a body surface of the animal;
a window in the wrapping to expose a portion of the body surface;
a spacer located between the wrapping and the body surface, wherein the spacer elevates a top of the window above the body surface;
a breathable material comprising a screen attached to the wrapping and covers the window to promote air flow and restrict passage of objects;
a first side; and
a second side being temporarily securable to the first side.

10. The bandage of claim 9, wherein the bandage is configured to wrap around the portion of the animal.

11. The bandage of claim 9, wherein the wrapping comprises cloth.

12. The bandage of claim 9, wherein the window is configured to substantially cover a wound on the animal.

13. The bandage of claim 12, wherein the spacer elevates the window above the wound.

14. The bandage of claim 9, wherein the spacer is located substantially about the window.

15. The bandage of claim 9, further comprising an adhesive applied to at least part of a bottom surface of the wrapping.

16. The bandage of claim 9, wherein the breathable material comprises a screen.

17. The bandage of claim 16, wherein the objects comprise insects, wherein the screen comprises a mesh with sufficiently small openings to minimize passage the insects.

18. A method of protecting a wound on an animal using a bandage with a wrapping, a spacer and a window, the method comprising:
(a) locating the window over a portion of the animal with the wound, wherein the window is located in the wrapping;
(b) positioning the spacer around the wound to elevate a top of the window over the wound, wherein the spacer is attached to the wrapping adjacent to the window, and wherein the spacer is locatable between the wrapping and a body surface of the animal;
(c) at least partially contacting the body surface of the animal with the wrapping; and
(d) securing the bandage using the wrapping;
wherein a breathable material attached to the wrapping and covers the window is configured to substantially cover the wound on the animal, promote air flow, and restrict passage of objects.

19. The bandage of claim 18, wherein the bandage comprises a first side and a second side, wherein the bandage is configured to wrap around the portion of the animal such that the first side is securable to the second side.

20. The bandage of claim 18, wherein the wrapping comprises a stretchable cloth, wherein the spacer is located substantially about the window to elevate the window above the wound, wherein the breathable material comprises a screen, wherein the objects comprise insects, wherein the screen comprises a mesh with sufficiently small openings to minimize passage the insects.
